(19) United States
(12) Patent Application Publication
(10) Pub. No.: US 2014/0167667 A1
(43) Pub. Date: Jun. 19, 2014

(54) MOTOR DRIVING APPARATUS AND METHOD

(71) Applicant: SAMSUNG ELECTRO-MECHANICS CO., LTD., Suwon (KR)

(72) Inventor: Joo Yul KO, Gyunggi-do (KR)

(73) Assignee: SAMSUNG ELECTRO-MECHANICS CO., LTD., Suwon (KR)

(21) Appl. No.: 13/896,860

(22) Filed: May 17, 2013

(30) Foreign Application Priority Data
Dec. 17, 2012 (KR) 10-2012-0147312

(51) Int. Cl. H02P 6/18

(52) U.S. Cl. CPC H02P 6/182
USPC 318/400.35; 318/400.34

(57) ABSTRACT

There are provided a motor driving apparatus and method, the motor driving apparatus including a current detecting unit detecting a level of a driving current applied to a motor for each predetermined period, a current comparing unit comparing the level of the driving current detected by the current detecting unit in a previous period and the level of the driving current detected by the current detecting unit in a current period, and a controlling unit adjusting a level of a reference signal compared with a back electro motive force (BEMF) signal of the motor based on an output of the current comparing unit.

### CROSS-REFERENCE TO RELATED APPLICATIONS

This application claims the priority of Korean Patent Application No. 10-2012-0147312 filed on Dec. 17, 2012, in the Korean Intellectual Property Office, the disclosure of which is incorporated herein by reference.

### BACKGROUND OF THE INVENTION

1. Field of the Invention

The present invention relates to a motor driving apparatus and method of appropriately removing an offset value of a comparator according to a speed of a motor by determining a reference signal value of the comparator generating a zero crossing point signal in consideration of a level of a driving current in detecting a back electro motive force (BEMF) signal of the motor using the zero crossing point signal.

2. Description of the Related Art

In a motor driving apparatus not using a hall sensor, a position of a rotor may be detected using a zero crossing point (ZCP) of a back electro motive force (BEMF) signal. In order to detect the BEMF signal in a driving apparatus operating a three phase motor, BEMF voltage is measured in a floating phase. In this case, an output signal indicating the position of the rotor like an output signal of the hall sensor may be obtained using a zero crossing method of comparing points at which the BEMF voltage rises and drops in a unit floating by 60 degrees, with a predetermined reference voltage.

A BEMF voltage signal detected by a general method is a signal including noise due to various causes unlike in an ideal case. Therefore, in the case in which this BEMF signal is compared with the reference voltage, it may be difficult to accurately detect a zero crossing point. Particularly, the noise included in the BEMF voltage signal may be a noise signal having a high frequency. In order to detect a BEMF voltage signal that is not affected by noise and that is close to an ideal BEMF voltage signal, a process of allowing a BEMF voltage signal detected in the motor to pass through a low pass filter to remove the noise signal having the high frequency is required.

However, during a process of generating the BEMF voltage signal or a process of filtering the BEMF voltage signal using the low pass filter, an unintended delay may be generated. Therefore, an unintended offset value may be increased or decreased in a reference signal compared with the BEMF voltage signal. In this case, since an error may be included in the result obtained by comparing the BEMF voltage signal with the reference signal using the zero crossing method, the position of a rotor may not be accurately detected, such that an operation of the motor may not accurately controlled.

Patent Document 1, which relates to a speed control method and apparatus for a brushless DC motor, discloses a configuration in which a motor is controlled by detecting a phase of the current and matching phases of current and induced voltage with each other. Patent Document 2, relating to a motor driving control apparatus, discloses a method of controlling a phase difference according to a load applied to a motor to drive the motor. However, a method of detecting a current for operating a motor for each predetermined period to compare levels of detected current in respective predetermined periods with each other and setting a level of a reference signal compared with a BEMF signal according to the comparison result to accurately detecting a zero crossing point signal is not disclosed in both Patent Documents 1 and 2.

### RELATED ART DOCUMENT

(Patent Document 1) Korean Patent Laid-Open Publication No. 10-2001-0068529
(Patent Document 2) Korean Patent Laid-Open Publication No. 10-2001-0011017

### SUMMARY OF THE INVENTION

An aspect of the present invention provides a motor driving apparatus and method, capable of detecting a driving current for operating a motor for each predetermined period and comparing levels of the detected current with each other to determine an offset value determining a level of a reference signal according to the comparison result in setting a level of the reference signal compared with a BEMF signal. Therefore, the level of the reference signal may be set in consideration of levels of the current for operating the motor and a delay component of a filter through which the BEMF signal is generated, such that an operation of the motor may be accurately controlled.

According to an aspect of the present invention, there is provided a motor driving apparatus including: a current detecting unit detecting a level of a driving current applied to a motor for each predetermined period; a current comparing unit comparing the level of the driving current detected by the current detecting unit in a previous period and the level of the driving current detected by the current detecting unit in a current period; and a controlling unit adjusting a level of a reference signal compared with aback electromotive force (BEMF) signal of the motor based on an output of the current comparing unit.

The controlling unit may increase the level of the reference signal when the level of the driving current detected in the previous period is higher than that of the driving current detected in the current period and decrease the level of the reference signal when the level of the driving current detected in the previous period is lower than that of the driving current detected in the current period.

The motor driving apparatus may further include a comparing unit comparing the reference signal of which the level is adjusted by the controlling unit and the BEMF signal with each other to generate a zero crossing point (ZCP) signal, wherein the controlling unit may control an operation of the comparing unit using different signs such that the level of the reference signal is increased or decreased, in a section in which a level of the BEMF signal is increased and a section in which the level of the BEMF signal is decreased.

The controlling unit may adjust the level of the reference signal to correct an error due to a delay generated during detecting the BEMF signal from the motor or filtering the BEMF signal.

The motor driving apparatus may further include a memory storing a digital value of the driving current converted by an analog to digital converting circuit, wherein the current detecting unit detects the level of the driving current based on a period of a commutation signal for generating the driving current.

The current comparing unit may retrieve the value of the driving current in the previous period stored in the memory to compare the retrieved value with a value of the driving current in the current period detected by the current detecting unit.

The motor driving apparatus may further include a digital to analog converting circuit converting the output of the current comparing unit into an analog value, wherein the controlling unit may adjust the level of the reference signal according to variations in a level of a signal output by the digital-to-analog converting circuit.

The current comparing unit may increase the output of the digital-to-analog converting circuit when the digital value of the driving current in the previous period stored in the memory is higher than that of the driving current in the current period and decrease the output of the digital-to-analog converting circuit when the digital value of the driving current in the previous period stored in the memory is lower than that of the driving current in the current period.

According to another aspect of the present invention, there is provided a motor driving method including: detecting a level of a driving current for operating a motor for each predetermined period; comparing the level of the driving current detected in a previous period with the level of the driving current detected in a current period in the detecting of the level; and adjusting a level of a reference signal compared with a BEMF signal of the motor according to a result of the comparison, wherein in the adjusting of the level of the reference signal, the level of the reference signal is increased when the level of the driving current in the previous period is higher than that of the driving current in the current period, while the level of the reference signal is decreased when the level of the driving current in the previous period is lower than that of the driving current in the current period.

The detecting of the level of the driving current may include: detecting the level of the driving current based on a period of a commutation signal for generating the driving current; and storing the detected level of the driving current.

The motor driving method may further include comparing the reference signal of which the level is determined in the adjusting of the level of the reference signal with the BEMF signal to generate a zero crossing point (ZCP) signal.

In the adjusting of the level of the reference signal, an operation of the comparing unit may be controlled using different signs such that the level of the reference signal is increased or decreased, in a section in which a level of the BEMF signal is increased and a section in which the level of the BEMF signal is decreased.

In the adjusting of the level of the reference signal, the level of the reference signal may be adjusted, such that an error due to a delay generated during detecting the BEMF signal from the motor or filtering the BEMF signal may be corrected.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram schematically illustrating a motor driving apparatus according to an embodiment of the present invention;

FIG. 2 is a block diagram illustrating a configuration of a motor driving apparatus according to another embodiment of the present invention; and

FIG. 3 is a flow chart for describing a motor driving method according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

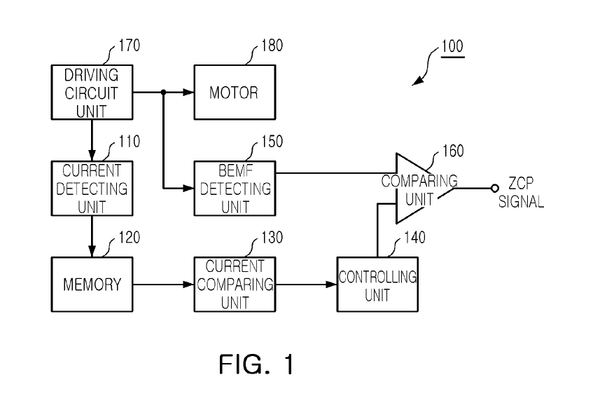

FIG. 1 is a block diagram schematically illustrating a motor driving apparatus according to an embodiment of the present invention.

Referring to FIG. 1, a motor driving apparatus 100 according to the embodiment of the present invention may include a current detecting unit 110 detecting a current for driving a motor 180, a memory 120 storing the detected current, a current comparing unit 130 comparing the current stored in the memory 120 and a currently detected current with each other, and a controlling unit 140 adjusting a level of a reference signal of a comparing unit 160 from the comparison result of the current comparing unit 130.

The motor 180 may be operated by the driving current output by a driving circuit unit 170. For example, the driving circuit unit 170 may include an inverter circuit. A rotational speed of a rotor included in the motor 180 may be determined by a level of the driving current applied from the driving circuit unit 170, and an operation of the motor 180 may be controlled by adjusting the level of the driving current applied to the motor 180. In this case, in order to more delicately adjust the operation of the motor 180, a position of the rotor needs to be detected. In the case in which the motor 180 is a sensorless type motor having no a hall sensor, the position of the rotor may be detected using a back electro motive force (BEMF) signal generated in the motor 180.

Referring to FIG. 1, a BEMF detecting unit 150 included in the motor driving apparatus 100 may detect the BEMF signal generated in the motor 180. The detected BEMF signal is input to the comparing unit 160 to thereby be compared with the reference signal of the comparing unit 160 adjusted by the controlling unit 140. In this case, the comparing unit 160 may compare the BEMF signal and the reference signal with each other to detect a zero crossing point, such that position information on the rotor of the motor 180 may be detected.

Therefore, in order to accurately detect the position of the rotor of the motor 180, the BEMF signal needs to be accurately generated, and the level of the reference signal of the comparing unit 160 needs to be appropriately set. In order to accurately generate the BEMF signal, generally, the BEMF signal may be allowed to pass through a low pass filter (LPF) capable of removing a noise signal generated in a frequency band higher than that of the BEMF signal.

However, the low pass filter generally has a predetermined delay component determined according to a filter feature. Therefore, when the BEMF signal is compared with the reference signal set by the comparing unit 160 after passing through the low pass filter, it may be difficult to accurately detect a zero crossing point due to the delay component generated in the low pass filter. Therefore, in the present invention, the controlling unit 140 may increase or decrease the level of a reference signal so as to correct this delay component. Hereinafter, a method of adjusting the level of the reference signal of the comparing unit 160 in the motor driving apparatus 100 may be described.

When the current detecting unit 110 detects the driving current for operating the motor 180 from the driving circuit unit 170, the memory 120 may store levels of the detected driving current. In this case, the current detecting unit 110 may periodically detect levels of the driving current in periods spaced apart by a predetermined interval. The current comparing unit 130 may retrieve the levels of the driving current stored in the memory to compare the levels with each other, particularly, a level of the driving current detected in an immediately previous period with a level of the driving current detected in a current period.

As a comparison result, in the case in which the level of the driving current detected in the current period is higher than the level of the driving current detected in the immediately previous period, as a comparison result, it may be considered that the level of the driving current applied to the motor 180 is gradually increased. Therefore, it may be estimated that a level of the BEMF signal generated in the motor 180 is also gradually increased. As a result, the delay component reflected in the BEMF signal due to the BEMF detecting unit 150 or the low pass filter filtering a noise component of the BEMF signal may delay the zero crossing point as compared with the case in which the delay component is not present. Therefore, the controlling unit 140 may reduce the level of the reference signal of the comparing unit 160, thereby correcting a delay phenomenon of the zero crossing point due to the delay component of the BEMF signal.

On the contrary, in the case the driving current of the current period has a level lower than that of the driving current in the immediately previous period, it may be considered that the level of the driving current applied to the motor 180 is gradually decreased. Therefore, the level of the BEMF signal generated in the motor 180 is also gradually decreased, and the delay component is reflected therein, such that an error in the zero crossing point may be generated as compared with the case in which the delay component is not included. The controlling unit 140 may increase the level of the reference signal of the comparing unit 160, thereby correcting the error in the zero crossing point.

Simply, the controlling unit 140 may adjust an offset value present in a reference signal terminal of the comparing unit 160 to adjust the level of the reference signal. In addition, as described above, the controlling unit 140 may apply a negative or positive offset value, that is, increase or decrease the level of the reference signal, with respect to each of the case in which the driving current applied to the motor 180 is increased and the case in which the driving current is decreased, such that a period of a commutation signal required to generate the driving current may be maintained.

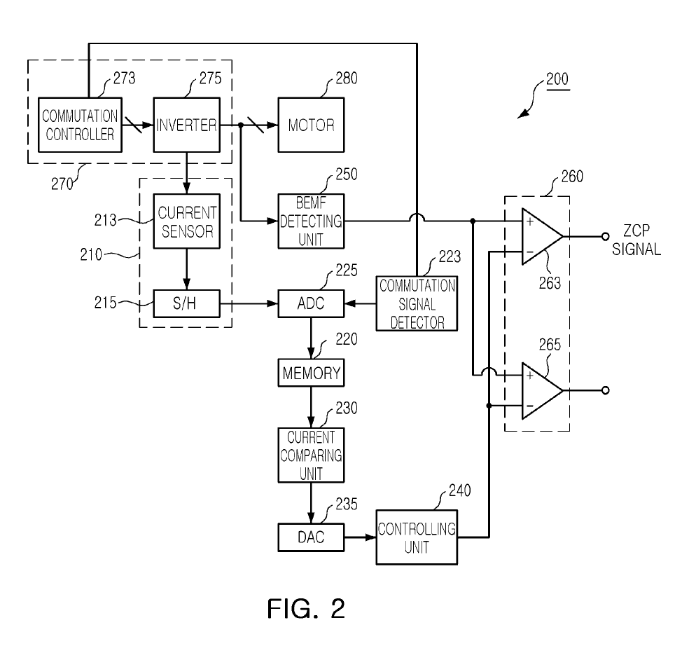

FIG. 2 is a block diagram illustrating a configuration of a motor driving apparatus according to another embodiment of the present invention.

Referring to FIG. 2, a motor driving apparatus 200 according to the embodiment of the present invention may include a current detecting unit 210, a memory 220, a current comparing unit 230, a controlling unit 240, a BEMF detecting unit 250, and a comparing unit 260, similarly to the motor driving apparatus 100 shown in FIG. 1. A driving circuit unit 270 for operating the motor 280 may include an inverter 275 generating a driving current and a commutation controller 273 controlling an operation of the inverter 275. The commutation controller 273 may sequentially control on and off switching operations of a plurality of switch devices included in the inverter 275, respectively, to control rotation of a motor 280.

The current detecting unit 210 may include a current sensor 213 detecting the driving current generated by the inverter 275 and a sample and hold circuit 215. The driving current detected by the current detecting unit 210 may be converted into a digital value through an analog to digital converter (ADC) 225 to thereby be stored in the memory 220. As the memory 220, a general register may be used.

A commutation signal detector 223 may detect periods of a signal controlling the on and off switching operations of the switch devices included in the inverter 275 from the commutation controller 273 to transfer the detected result to the ADC 225. The ADC 225 may convert information regarding a control signal of the commutation controller 273 into a digital value to store the digital value in the memory 220. The current comparing unit may compare levels of the driving current of the motor 280 periodically detected in periods spaced apart by a predetermined interval with each other as described above with reference to FIG. 1. In this comparing operation of the current comparing unit 230, the control signal of the commutation controller 273 detected by the commutation signal detector 223 may be used.

The inverter 275 may output different levels of the driving current according to a period of the commutation signal output from the commutation controller 273. Therefore, a period for detecting the driving current by the current detector 210 may correspond to the period of the commutation signal, and the current comparing unit 230 may retrieve and compare digital values of the levels of the driving current stored in the memory 220 using commutation signal information output from the commutation signal detector 223. As described above, the current comparing unit 230 may compare a digital value of a level of the driving current detected in an immediately previous period with that of a level of the driving current detected in a current period.

As a comparison result, when the digital value of the level of the driving current in the immediately previous period is higher than that of the level of the driving current in the current period, it may be estimated that the level of the BEMF signal generated from the motor 280 is gradually increased. Therefore, the controlling unit 240 needs to decrease the level of the reference signal of the comparing unit 260 in order to correct an error due to a delay component reflected in the BEMF detecting unit 250, a low pass filter, or the like. On the other hand, when the digital value of the level of the driving current in the current period is higher than that of the level of the driving current in the immediately previous period, it is considered that the level of the BEMF signal is gradually decreased. Therefore, in order to accurately detect the zero crossing point (ZCP) signal, the controlling unit 240 may increase the level of the reference signal.

Meanwhile, the motor driving apparatus may further include a digital to analog converting circuit converting the output of the current comparing unit into an analog value. The controlling unit may adjust the level of the reference signal according to variations in a level of a signal output by the digital-to-analog converting circuit.

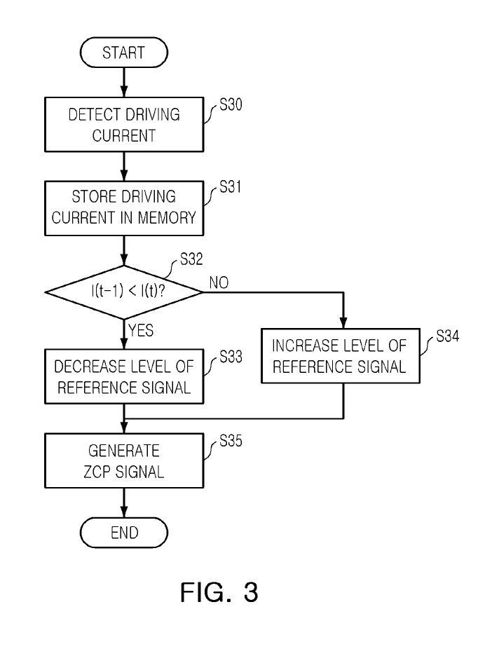

FIG. 3 is a flow chart for describing a motor driving method according to an embodiment of the present invention.

Referring to FIG. 3, in the motor driving method according to the embodiment of the present invention, first, the current detecting unit 210 may detect a driving current from the motor 280 (S30). The current detecting unit 210 may detect a level of the driving current using the current sensor 213 and the sample and hold circuit 215, and the detected level of the driving current may be converted into a digital value by the ADC 225 to thereby be stored in the memory 220 (S31).

Meanwhile, although omitted in the flow chart of FIG. 3, the motor driving apparatus 200 may retrieve information on the commutation signal required to generate the driving current of the motor 280 using the commutation signal detector 223. The on and off switching operations of switch devices included in the inverter 275 generating the driving current may be changed according to the period of the commutation signal. Therefore, since the level of the driving current maybe changed according to the period of the commutation signal, the current detecting unit 210 may sample the detected levels of the driving current according to the period of the commutation signal, and the sampled current levels may be compared to each other in the current comparing unit 230.

The current comparing unit 230 may compare a digital value I(t-1) of the level of the driving current detected in the immediately previous period with a digital value I(t) of the level of the driving current detected in the current period (S32). As a comparison result in S32, when the digital value I (t-1) is lower than the digital value I(t), it may be considered that the level of the driving current is gradually increased, such that it may be estimated that the level of the BEMF signal output from the motor 280 is gradually increased. Therefore, the controlling unit 240 may decrease the level of the reference signal compared with the BEMF signal in the comparing unit 260 in order to correct an error in the ZCP signal (S33).

On the other hand, as a comparison result in S32, when the digital value I(t-1) is higher than I(t), it may be considered that the level of the driving current and the level of the BEMF signal are gradually decreased. Therefore, the controlling unit 240 may increase the level of the reference signal compared with the BEMF signal in the comparing unit 260 in order to correct an error of the ZCP signal (S34). As described above, the level of the reference signal of the comparing unit 260 is adjusted in S33 and S34, such that the error in the ZCP signal due to a delay component included in the BEMF signal may be effectively corrected.

Finally, the motor driving apparatus may compare the level of the reference signal corrected in S33 or S34 with that of the BEMF signal to generate the ZCP signal (S35). Through the above-mentioned processes, even in the case in which a delay component is present in the BEMF signal detected in the motor 280, the ZCP signal may be accurately generated, such that the operation of the motor 280 may be accurately controlled.

As set forth above, according to the present invention, in detecting the position of rotor based on the BEMF signal obtained from the motor, the level of the reference signal compared with that of the BEMF signal may be determined based on changes in the level of the driving current for operating the motor. Therefore, the position of the rotor of the motor may be accurately detected from the BEMF signal by determining the level of the reference signal compared with the BEMF signal in consideration of all the operating speed of the rotor and the delay component of the filter through which the BEMF signal is generated, whereby the operation of the motor may be accurately controlled.

While the present invention has been shown and described in connection with the embodiments, it will be apparent to those skilled in the art that modifications and variations can be made without departing from the spirit and scope of the invention as defined by the appended claims.

What is claimed is:

1. A motor driving apparatus comprising:
a current detecting unit detecting a level of a driving current applied to a motor for each predetermined period;
a current comparing unit comparing the level of the driving current detected by the current detecting unit in a previous period and the level of the driving current detected by the current detecting unit in a current period; and
a controlling unit adjusting a level of a reference signal compared with a back electro motive force (BEMF) signal of the motor based on an output of the current comparing unit.

2. The motor driving apparatus of claim 1, wherein the controlling unit increases the level of the reference signal when the level of the driving current detected in the previous period is higher than that of the driving current detected in the current period and decreases the level of the reference signal when the level of the driving current detected in the previous period is lower than that of the driving current detected in the current period.

3. The motor driving apparatus of claim 1, further comprising a comparing unit comparing the reference signal of which the level is adjusted by the controlling unit and the BEMF signal with each other to generate a zero crossing point (ZCP) signal,
wherein the controlling unit controls an operation of the comparing unit using different signs such that the level of the reference signal is increased or decreased, in a section in which a level of the BEMF signal is increased and a section in which the level of the BEMF signal is decreased.

4. The motor driving apparatus of claim 1, wherein the controlling unit adjusts the level of the reference signal to correct an error due to a delay generated during detecting the BEMF signal from the motor or filtering the BEMF signal.

5. The motor driving apparatus of claim 1, further comprising a memory storing a digital value of the driving current converted by an analog to digital converting circuit,
wherein the current detecting unit detects the level of the driving current based on a period of a commutation signal for generating the driving current.

6. The motor driving apparatus of claim 5, wherein the current comparing unit retrieves the value of the driving current in the previous period stored in the memory to compare the retrieved value with a value of the driving current in the current period detected by the current detecting unit.

7. The motor driving apparatus of claim 6, further comprising a digital to analog converting circuit converting the output of the current comparing unit into an analog value,
wherein the controlling unit adjusts the level of the reference signal according to variations in a level of a signal output by the digital-to-analog converting circuit.

8. The motor driving apparatus of claim 7, wherein the current comparing unit increases the output of the digital-to-analog converting circuit when the digital value of the driving current in the previous period stored in the memory is higher than that of the driving current in the current period and decreases the output of the digital-to-analog converting circuit when the digital value of the driving current in the previous period stored in the memory is lower than that of the driving current in the current period.

9. A motor driving method comprising:
detecting a level of a driving current for operating a motor for each predetermined period;
comparing the level of the driving current detected in a previous period with the level of the driving current detected in a current period in the detecting of the level; and
adjusting a level of a reference signal compared with a BEMF signal of the motor according to a result of the comparison,
wherein in the adjusting of the level of the reference signal, the level of the reference signal is increased when the level of the driving current in the previous period is higher than that of the driving current in the current period, while the level of the reference signal is decreased when the level of the driving current in the previous period is lower than that of the driving current in the current period.

10. The motor driving method of claim 9, wherein the detecting of the level of the driving current includes:
detecting the level of the driving current based on a period of a commutation signal for generating the driving current; and
storing the detected level of the driving current.

11. The motor driving method of claim 9, further comprising comparing the reference signal of which the level is determined in the adjusting of the level of the reference signal with the BEMF signal to generate a zero crossing point (ZCP) signal.

12. The motor driving method of claim 9, wherein in the adjusting of the level of the reference signal, an operation of the comparing unit is controlled using different signs such that the level of the reference signal is increased or decreased, in a section in which a level of the BEMF signal is increased and a section in which the level of the BEMF signal is decreased.

13. The motor driving method of claim 9, wherein in the adjusting of the level of the reference signal, the level of the reference signal is adjusted, such that an error due to a delay generated during detecting the BEMF signal from the motor or filtering the BEMF signal is corrected.
